(19) United States
(12) Patent Application Publication
(10) Pub. No.: US 2010/0093452 A1
(43) Pub. Date: Apr. 15, 2010

(54) Constant Velocity Joint

(75) Inventor: Jaeman KIM, Hwaseong-si (KR)

Correspondence Address: MORGAN, LEWIS & BOCKIUS LLP (SF), One Market, Spear Street Tower, Suite 2800, San Francisco, CA, 94105, US

(73) Assignee: HYUNDAI MOTOR COMPANY, Seoul (KR)

(21) Appl. No.: 12/325,927

(22) Filed: Dec. 1, 2008

(30) Foreign Application Priority Data
Oct. 13, 2008 (KR) 10-2008-0100067

(51) Int. Cl. F16D 3/26

(52) U.S. Cl. 464/111

(57) ABSTRACT

A constant velocity joint may include a roller including a roller body and a bearing receiving portion formed on one lateral side of the roller body, wherein the roller is guided and moved on a track of the constant velocity joint, and a bearing mounted in the bearing receiving portion and a portion of which protrudes outside the one lateral side of the roller in rotation axis direction of the roller, wherein the bearing is guided and moved in the bearing receiving portion of the roller.

### CROSS-REFERENCE TO RELATED APPLICATIONS

The present application claims priority to Korean Patent Application Number 10-2008-0100067 filed Oct. 13, 2008, the entire contents of application is incorporated herein for all purposes by this reference.

### BACKGROUND OF THE INVENTION

1. Field of the Invention

The present invention relates to a constant velocity joint, and more particularly, to a constant velocity joint in which a bearing is mounted on a cap of a roller moving in a track of a joint housing.

2. Description of Related Art

Generally, a constant velocity joint is a device that is installed on a driving vehicle shaft connected to a final reduction gear to transmit power to a wheel at constant velocity in a front wheel drive vehicle. FIG. 1 is a schematic diagram illustrating a state in which a known constant velocity joint is applied to a drive shaft.

That is, a left drive shaft 3 for driving a left wheel is connected to a transmission 2 for transmitting rotation power of an engine 1 by means of a constant velocity joint 4. Similarly, constant velocity joint 4 is applied to a right drive shaft 5 for driving a right wheel.

As described above, in the case when a road surface is rough or the vehicle is turned in a state where a drive shaft is connected to a transmission by means of the constant velocity joint, a wheel is bumped or rebounded in driving the vehicle. The bumping or rebounding of the wheel is transmitted to the constant velocity joint through each drive shaft, such that external force is applied to the constant velocity joint in left and right shaft directions as indicated by means of an arrow in FIG. 1.

As described above, in order to properly absorb the axis-directional external force applied to the constant velocity joint, in the known constant velocity joint, a plurality of tracks 4b are formed in a constant velocity joint housing 4a and a roller 4d mounted on a front end portion of a tripod 4c is inserted in each track 4b, such that roller 4d properly absorbs the shaft-direction force applied to the constant velocity joint while rotating and moving, as shown in FIG. 2.

An axis-directional movement of tripod 4c is called a plunging movement. When the roller moves on the track in the shaft direction, roller 4d moves with the side of roller 4d coming in contact with an inner peripheral surface of the track as shown in FIG. 3. As a result, sliding friction is generated between the side of the roller and the inner peripheral surface. Further, sliding friction interferes with the plunging movement to deteriorate vibration of the vehicle in an idle state at the time of parking the vehicle.

An angle difference between the drive shaft and the transmission in starting the vehicle increases, such that the plunging movement of the constant velocity joint also increases. As a result, the sliding friction generated between the roller of the constant velocity joint and the track increase and shudder in which the vehicle greatly shudders left and right occurs, thereby deteriorating ride comfort.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a constant velocity joint which is capable of improving ride comfort by reducing vibration of a vehicle through reducing sliding friction generated between a roller of the constant velocity joint and a track to the minimum to promote a smooth plunging movement of the constant velocity joint.

In an aspect of the present invention, a constant velocity joint may include a plurality of bearings mounted on one lateral side of a roller guide and moved on a track of the constant velocity joint, wherein the bearings protrudes outside the one lateral side of the roller and are disposed at a predetermined angle therebetween in a circumferential direction of the roller.

The bearings may be mounted on a bearing track that is formed on the lateral side of the roller.

The bearings may be inserted in the roller and a portion of the bearing may protrude from a cap through a respective hole formed at the cap, wherein the cap is mounted on the one lateral side of the roller.

The bearings may be mounted in two on the cap at 180 degrees in the circumferential direction therebetween.

The track may be formed in plural in a housing of the constant velocity joint at a predetermined interval in the circumferential direction thereof, a plurality of the roller may be inserted in the housing along the track and rotatably mounted on three front end portions of a tripod that is inserted into the housing to be movable in a shaft direction of the housing.

In another aspect of the present invention, a constant velocity joint may include a roller including a roller body and a bearing receiving portion formed on one lateral side of the roller body, wherein the roller is guided and moved on a track of the constant velocity joint, and/or a bearing mounted in the bearing receiving portion and a portion of which protrudes outside the one lateral side of the roller in rotation axis direction of the roller, wherein the bearing is guided and moved in the bearing receiving portion of the roller. The bearing receiving portion may be a bearing track formed in the roller body.

The bearing track may be formed co-axial with rotation axis of the roller in the roller body.

A plurality of bearing tracks may be formed co-axial with rotation axis of the roller in the roller body.

A plurality of bearings may be disposed at a predetermined angle in a circumferential direction of the roller body therebetween. The bearings may be mounted in two in the bearing receiving portion approximately at 180 degrees in the circumferential direction therebetween.

The bearing may be inserted in a cap that is mounted on one lateral side of the roller body and a portion of the bearing protrudes outwards through a respective hole formed on a lateral surface of the cap, diameter of the hall being smaller than that of the bearing.

The cap may be rotatably mounted to the roller body to receive the bearing between the cap and the roller body.

The cap may be attached to the roller body to receive the bearing between the cap and the roller body.

The track may be formed in plural in a housing of the constant velocity joint at a predetermined interval in the circumferential direction thereof a plurality of the roller are inserted in the housing along the track and rotatably mounted on three front end portions of a tripod that is inserted into the housing to be movable in a shaft direction of the housing.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a diagram illustrating a state in which a drive shaft is connected by means of a known constant velocity joint.

FIG. 2 is a cutaway perspective view of a known constant velocity joint.

FIG. 3 is an internal cross-sectional view of a known constant velocity joint.

FIG. 4 is a perspective view of a state in which a drive shaft is connected by means of an exemplary constant velocity joint according of the present invention.

FIG. 5 is assembling and disassembling perspective views of a constant velocity joint according to an exemplary embodiment of the present invention.

FIG. 6 is a cross-sectional view illustrating an operation of a constant velocity joint according to an exemplary embodiment of the present invention.

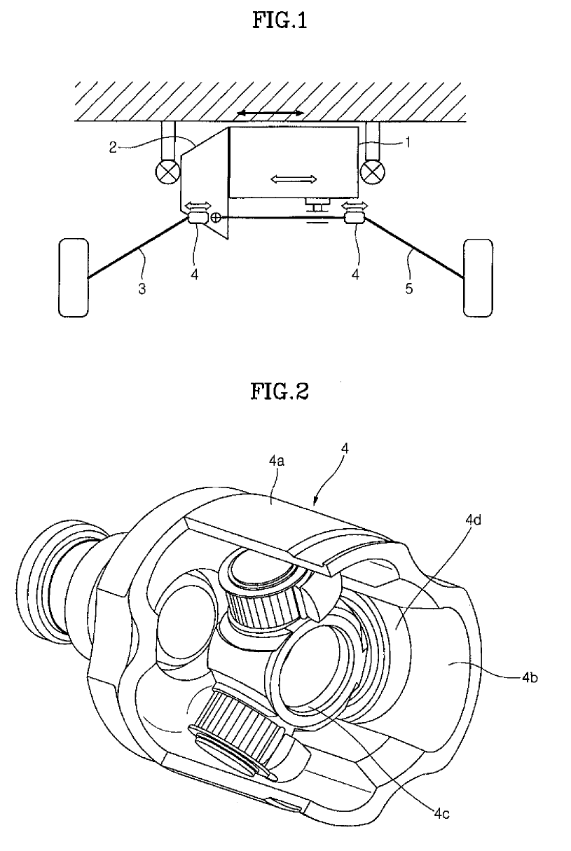

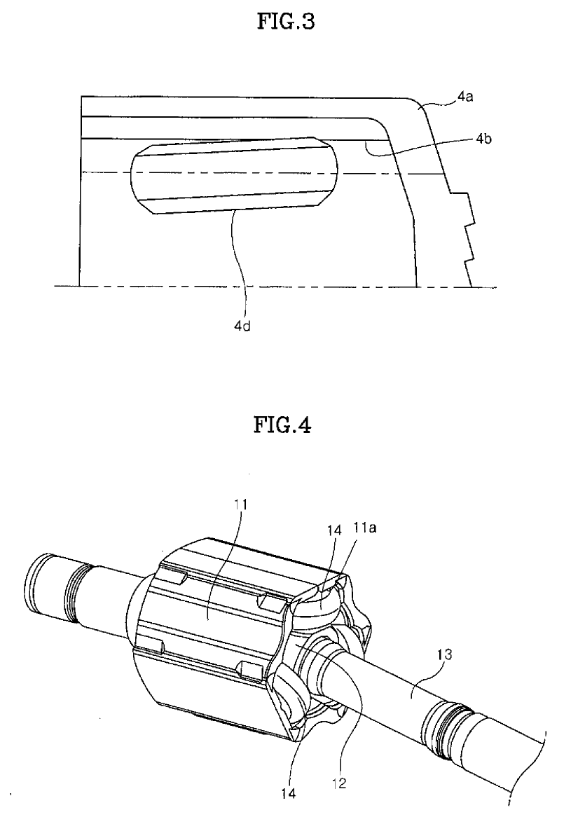

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

FIG. 4 is a perspective view illustrating a state in which a driver shaft is connected by means of a constant velocity joint according to an exemplary embodiment of the present invention.

Three tracks 11a are formed in a constant velocity joint housing 11 having an opened cylindrical shape at one side in a longitudinal direction of the housing circumferentially at 120 degrees. A tripod 12 is inserted in housing 11 to allow tripod 12 to move in the longitudinal direction of the housing. One end of a drive shaft 13 fits in tripod 12. Rollers 14 are rotatably mounted on three front end portions of tripod 12, respectively. Rollers 14 are inserted in tracks 11a to rotate on tracks 11a.

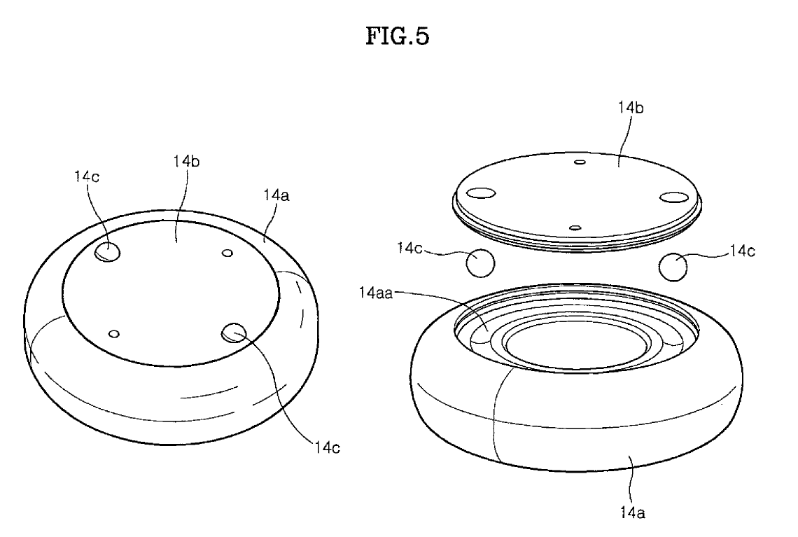

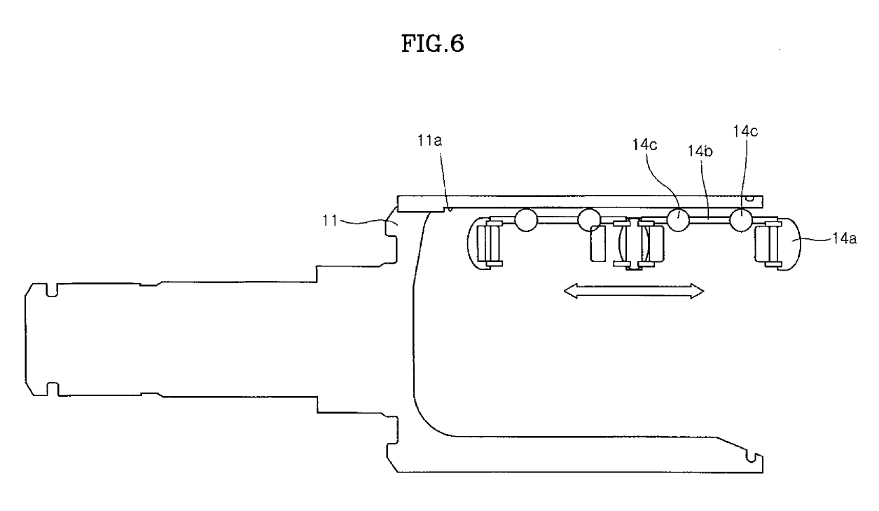

FIG. 5 is assembling and disassembling perspective views of a constant velocity joint according to an exemplary embodiment of the present invention.

Each of rollers 14 includes a circular roller body 14a having an assembling hole formed in the center portion thereof and a bearing track 14aa dented concavely in a circumferential direction, a cap 14b mounted to cover one lateral side of roller body 14a, and two bearings 14c that are inserted in cap 14b and are disposed circumferentially at 180 degrees.

Bearing 14c is installed to project the outside of one lateral side of the cap 14b.

Although it has been described that two bearings 14c are provided in the embodiment of the present invention, two or more bearings 14c may be installed.

In an exemplary embodiment of the present invention, the cap 14b may be rotatably coupled with the roller body 14a. Accordingly when the constant velocity joint performs a plunging movement while the roller having the bearings 14c rotates and moves on the bearing track 14aa with rotation of the cap 14b, the bearings 14c mounted on the cap 14b come in contact with an inner peripheral surface of track 11a while moving on bearing track 14aa of the roller.

In another exemplary embodiment of the present invention, the cap 14b may be snapped to the roller body 14a and not rotatable with the roller body 14a. Accordingly when the constant velocity joint performs a plunging movement while the roller having the bearings 14c rotates and moves on the bearing track 14aa, the bearings 14c protruding from the cap 14b come in contact with an inner peripheral surface of track 11a while rotating on a portion of the bearing track 14aa of the roller.

In further another exemplary embodiment of the present invention, the roller body 14a may have a plurality of bearing tracks 14aa according to the size of the roller.

Since it is possible to effectively prevent a direct contact between the side of the roller and the inner peripheral surface of the track and sliding friction, the roller is smoothly guided and moved on the track and thus the plunging movement of the constant velocity joint becomes smooth, whereby it is possible to smoothly transmit power to the driver shaft and improve ride comfort of the vehicle by preventing vibration, i.e., swing or shudder of the vehicle due to the sliding friction between the side of the roller and the track when the vehicle is in an idle state or is started.

For convenience in explanation and accurate definition in the appended claims, the terms “front”, “interior”, and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A constant velocity joint, comprising:
a plurality of bearings mounted on one lateral side of a roller guide and moved on a track of the constant velocity joint, wherein the bearings protrudes outside the one lateral side of the roller and are disposed at a predetermined angle therebetween in a circumferential direction of the roller.

2. The constant velocity joint as defined in claim 1, wherein the bearings are mounted on a bearing track that is formed on the lateral side of the roller.

3. The constant velocity joint as defined in claim 1, wherein the bearings are inserted in the roller and a portion of the bearing protrudes from a cap through a respective hole formed at the cap, wherein the cap is mounted on the one lateral side of the roller.

4. The constant velocity joint as defined in claim 3, wherein the bearings are mounted in two on the cap at 180 degrees in the circumferential direction therebetween.

5. The constant velocity joint as defined claim 4, wherein the track is formed in plural in a housing of the constant velocity joint at a predetermined interval in the circumferential direction thereof a plurality of the roller are inserted in the housing along the track and rotatably mounted on three front end portions of a tripod that is inserted into the housing to be movable in a shaft direction of the housing.

6. A passenger vehicle comprising the constant velocity joint as defined claim 1.

7. A constant velocity joint, comprising:
a roller including a roller body and a bearing receiving portion formed on one lateral side of the roller body, wherein the roller is guided and moved on a track of the constant velocity joint; and
a bearing mounted in the bearing receiving portion and a portion of which protrudes outside the one lateral side of the roller in rotation axis direction of the roller, wherein the bearing is guided and moved in the bearing receiving portion of the roller.

8. The constant velocity joint as defined in claim 7, wherein the bearing receiving portion is a bearing track formed in the roller body.

9. The constant velocity joint as defined in claim 8, wherein the bearing track is formed co-axial with rotation axis of the roller in the roller body.

10. The constant velocity joint as defined in claim 7, wherein a plurality of bearing tracks are formed co-axial with rotation axis of the roller in the roller body.

11. The constant velocity joint as defined in claim 7, wherein a plurality of bearings are disposed at a predetermined angle in a circumferential direction of the roller body therebetween.

12. The constant velocity joint as defined in claim 11, wherein the bearings are mounted in two in the bearing receiving portion approximately at 180 degrees in the circumferential direction therebetween.

13. The constant velocity joint as defined in claim 7, wherein the bearing is inserted in a cap that is mounted on one lateral side of the roller body and a portion of the bearing protrudes outwards through a respective hole formed on a lateral surface of the cap, diameter of the hall being smaller than that of the bearing.

14. The constant velocity joint as defined in claim 13, wherein the cap is rotatably mounted to the roller body to receive the bearing between the cap and the roller body.

15. The constant velocity joint as defined in claim 13, wherein the cap is attached to the roller body to receive the bearing between the cap and the roller body.

16. The constant velocity joint as defined claim 7, wherein the track is formed in plural in a housing of the constant velocity joint at a predetermined interval in the circumferential direction thereof, a plurality of the roller are inserted in the housing along the track and rotatably mounted on three front end portions of a tripod that is inserted into the housing to be movable in a shaft direction of the housing.

17. A passenger vehicle comprising the constant velocity joint as defined claim 7.
